(19) United States
(12) Patent Application Publication
(10) Pub. No.: US 2018/0167319 A1
(43) Pub. Date: Jun. 14, 2018

(54) APPLICATION IDENTIFICATION CACHE

(71) Applicant: Hewlett Packard Enterprise Development LP, Houston, TX (US)

(72) Inventors: Theodore Qian, Palo Alto, CA (US); David Malicoat, Roseville, CA (US); Yung-Ching Tseng, Palo Alto, CA (US)

(21) Appl. No.: 15/580,549

(22) PCT Filed: Jun. 12, 2015
(86) PCT No.: PCT/US15/35509

§ 371 Date: Dec. 7, 2017

(51) Int. Cl. H04L 12/747; H04L 29/06; H04L 12/26; H04L 12/859; H04L 12/725; H04L 12/721

(52) U.S. Cl. CPC H04L 45/742; H04L 69/22; H04L 45/38; H04L 47/2475; H04L 45/302; H04L 43/028

(57) ABSTRACT

In some examples, a method includes parsing a packet received by the network device to identify a packet header value of the packet and performing a lookup into an application identification cache using the packet header value to identify the packet as part of a traffic flow of a particular application.

### BACKGROUND

High speed communication networks form part of the backbone of what has become indispensable worldwide data connectivity. Within these communication networks, network devices such as switching devices direct network traffic from source ports to destination ports, helping to eventually guide a data packet from a source to a destination. Improvements in the efficiency of such communication networks will increase the effectiveness of communicating data.

### BRIEF DESCRIPTION OF THE DRAWINGS

Certain examples are described in the following detailed description and in reference to the drawings.

FIG. 1 shows an example of a device that may implement an application identification cache.

FIG. 2 shows an example of a lookup into an application identification cache by a cache manager.

FIG. 3 shows an example of a cache manager forwarding a packet and application identifier to packet forwarding circuitry.

FIG. 4 shows an example of a cache update by the cache manager.

FIG. 5 shows another example of a cache update by the cache manager.

FIG. 6 shows an example of logic that a network device may implement.

FIG. 7 shows another example of logic that a network device may implement.

FIG. 8 shows an example of a device that may maintain an application identification cache.

### DETAILED DESCRIPTION

The discussion herein may provide devices, circuitry, systems, logic, and methods to implement an application identification cache through a network device. The application identification cache may support identification of an application that network traffic (e.g., packets) belongs to or originates from. A cache hit in the application identification cache may support application recognition for a packet stream without, for example, deep packet inspection or other resource intensive processes. Thus, the application identification cache may reduce device resource usage and increase the efficiency and speed of packet routing and communication. These features may be particularly beneficial for encrypted application data flows, as application identification through the application identification cache without deep packet inspection may additionally reduce or eliminate resource usage for decrypting the application data flow as well.

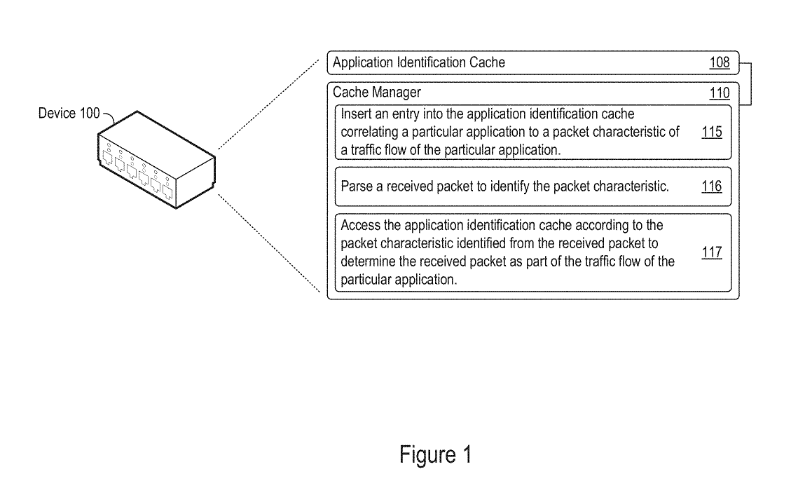

FIG. 1 shows an example of a device 100 that may implement an application identification cache. The device 100 may be any computing or network device that communicates data. As examples, the device 100 may take the form of a router, server, switch, gateway, network edge device, client device, and more. The device 100 may include any circuitry or logic to perform packet routing, and according to any number of methods or protocols and across any number of communication networks types.

In the example shown in FIG. 1, the device 100 includes an application identification cache 108. The device 100 may implement the application identification cache 108 as any type of data structure, and any various physical and virtual implementations are possible. For example, the application identification cache 108 may take the form of a cache memory, table, database, or various other data storage entities. In operation, the application identification cache 108 may store entries correlating traffic flows to applications (e.g., client programs) originating these traffic flows. For instance, an entry of the application identification cache 108 may pair a packet characteristic of a traffic flow to an application identifier of the corresponding application that generated the traffic flow. Features and examples of the application identification cache 108 are discussed in greater detail below.

The device 100 shown in FIG. 1 also includes a cache manager 110, which may maintain, update, and access the application identification cache 108. The cache manager 110 may be implemented by the device 100 through any combination of a sub-system, module, dedicated circuitry, logic, executable instructions stored on a machine-readable medium, and various other forms. The cache manager 110 may access the application identification cache 108 to identify a particular application that received network traffic belongs to, such as by identifying a received packet as part of a traffic flow of the particular application.

In the particular example shown in FIG. 1, the cache manager 110 includes the modules 115, 116, and 117 which may implement features that the cache manager 110 may provide. For instance, through the modules 115, 116, and 117, the cache manager 110 may insert an entry into the application identification cache 108 correlating a particular application to a packet characteristic of a traffic flow of the particular application; parse a packet header of a received packet to identify the packet characteristic; and access the application identification cache 108 according to the packet characteristic to determine the received packet as part of the traffic flow of the particular application. Examples features of the application identification cache 108 and the cache manager 110 are discussed in greater detail next.

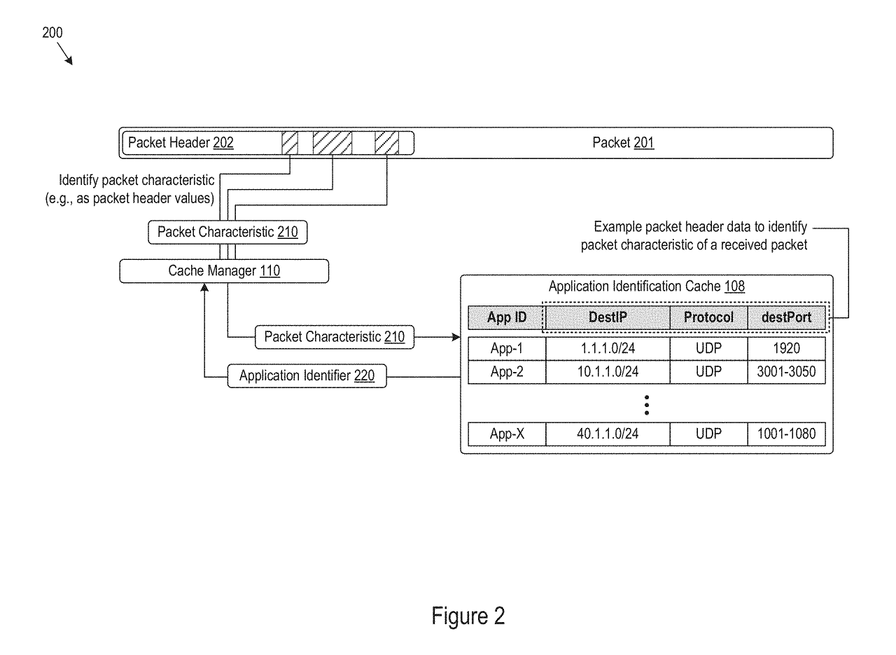

FIG. 2 shows an example of a lookup into an application identification cache 108 by the cache manager 110. The cache manager 110 may perform a lookup into the application identification cache 108 for network traffic received by a network device, such as packet data. In the example shown in FIG. 2, the cache manager 110 performs a lookup into the application identification cache 108 for the packet 201, allowing the cache manager 110 to determine an application for which the packet 201 belongs to (e.g., is transporting application data for).

To support application identification for network traffic, the application identification cache 108 may store cache entries that respectively map an application to a packet characteristic for a traffic flow of the application. A traffic flow may refer to any data stream carrying application data of an application, such as a sequence of packets for a specific transport connection, a media data stream, and more. The application identification cache 108 may identify or track various applications through application identifiers, which may be configured by a network administrator or recognized across multiple network devices in a communication network. FIG. 2 shows an example of an application identification cache 108 that includes an “App ID” field for entries in the application identification cache 108, which may specify an application identifier that corresponds to an application. And as seen in the example in FIG. 2, the application identification cache 108 includes example entries for the applications identified as “App-1”, “App-2”, and “App-X”. These example entries map the application identifiers to respective packet characteristics.

A packet characteristic of a traffic flow may be any attribute, parameter, value, or other characteristic that a packet in the traffic flow contains. In some examples, the application identification cache 108 maps an application (e.g., through an application identifier) to a packet characteristic in the form of particular packet header values identifying a traffic flow of the application. Any combination of packet header values may be used by the application identification cache 108 as a packet characteristic. Examples of such packer header values include a source address (e.g., a source internet protocol (IP) address or source Ethernet or media access control (MAC) address), a destination address (e.g., a destination IP or MAC address), a communication protocol in use (e.g., a transport layer protocol such as transmission control protocol (TOP), user datagram protocol (UDP), or others), or a communication port (e.g., a source port or destination port).

Other examples of packet header values the application identification cache 108 may map to an application include any quality of service (QoS) attributes of a packet, metadata values (e.g., a header metadata value of an application identifier itself), priority fields, network identification bits, and more. To provide even more examples, the packet characteristic make take the form of a TCP connection 5-tuple or an OpenFlow 12-tuple. In the specific example shown in FIG. 2, entries in the application identification cache 108 include a destination IP address field (shown as “DestIP”), protocol in use (shown as “Protocol”), and destination port (shown as “destPort”). These packet header values may together form an example packet characteristic that the application identification cache 108 maps to an application identifier.

The application identification cache 108 may store any number of entries for a particular application. In that regard, the application identification cache 108 may support identification of the particular application through multiple, different packet characteristics. Thus, the application identification cache 108 may include a first entry mapping a particular application (e.g., with application identifier “App-A”) to a particular TCP connection 5-tuple and a second entry mapping the particular application to a particular metadata value specified in a packet header. By supporting multiple entries for the same application, the application identification cache 108 may provide flexibility in a network device to select, configure, or vary which particular packet characteristic(s) to use in identifying an application.

To perform a lookup into the application identification cache 108, the cache manager 110 may identify a packet characteristic of the packet 201. In FIG. 2, the packet 201 includes the packet header 202 and the cache manager 110 may parse the packet 201 to identify specific packet header values in the packet header 202 as the packet characteristic of the packet 201 (shown in FIG. 2 as the packet characteristic 210). Then, the cache manager 110 may perform a lookup into the application identification cache 108 according to the packet characteristic 210 of the packet 201. When the lookup results in a cache hit (e.g., when the application identification cache 108 includes an entry for the packet characteristic 210), the application identification cache 108 may return an application identifier 220 to the cache manager 110. In doing so, the cache manager 110 may identify the packet 201 as part of a traffic flow of an application corresponding to the returned application identifier 220. When the lookup results in a cache miss, the cache manager 110 may not receive an application identifier for the packet 201.

To illustrate through the example shown in FIG. 2, the cache manager 110 may parse the packet 201 to identify the packet characteristic 210 as a destination IP address of “1.1.1.0/24”, a protocol as “UDP”, and a destination port as “1920”. Using these packet header values as the packet characteristic 210, a lookup into the application identification cache 108 by the cache manager 110 returns a cache hit, and the application identification cache 108 may return the application identifier 220 as “App-1”. Thus, the cache manager 110 may identify the packet 201 as part of a traffic flow for the application corresponding to the application identifier “App-1”, retrieved through the application identification cache 108.

By determining a corresponding application for network traffic through the application identification cache 108, the cache manager 110 may reduce resource usage were such application recognition performed instead through deep packet inspection or other resource-intensive application recognition techniques. In that regard, use of the application identification cache 108 may result in improved data routing performance, allowing network devices to determine and route packets more efficiently, quicker, and with less resource consumption (e.g., with reduced deep packet inspection). Moreover, deep packet inspection processes may require decrypting of encrypted packet data to perform application recognition, such as through inspection of packet payload data for data signatures or other content. In such scenarios, using the application identification cache 108 may further reduce resource usage through bypassing such decryption processes as well.

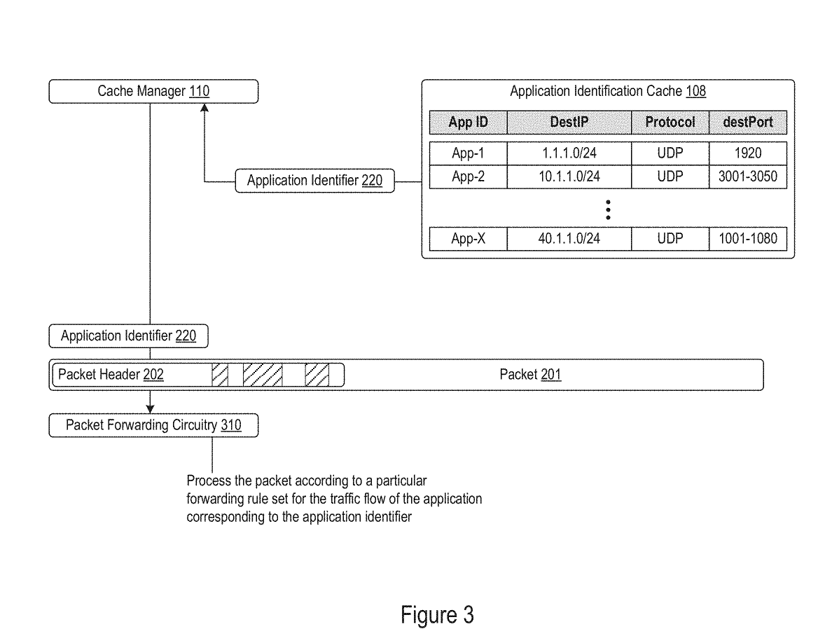

Through application identification via the application identification cache 108, a network device may support application-specific routing of traffic flows. FIG. 3 shows an example of a cache manager 110 forwarding a packet 201 and application identifier 220 to packet forwarding circuitry 310. The packet forwarding circuitry 310 may include any packet routing or forwarding logic, such as packet forwarding pipeline implemented by a network device. As such, the packet forward circuitry 310 may process packets according to various packet forwarding rules (e.g., policies), which may control the priority, bandwidth, resource allocation, or other processing characteristics by which the packet forwarding circuitry 310 processes different packet types for routing. In some examples, the packet forwarding circuitry 310 may differentiate between network traffic from different applications, e.g., by applying different forwarding rules for traffic flows of the different applications. In FIG. 3, the packet forwarding circuitry 310 processes the packet 201 according to a particular forwarding rule set for the traffic flow of the application corresponding to the application identifier 220.

As an example of a particular networking environment, the application identification cache 108 may be implemented among network devices of a wide area network (WAN) employing software defined networking (SDN) techniques. The SDN WAN network may use the OpenFlow protocol to control routing policies of network devices, e.g., via packet forwarding rules. In such an environment, the application identification cache 108 may support application-specific routing by providing an efficient and flexible mechanism for application recognition and subsequent packet processing. To illustrate, a network device may implement the application identification cache 108 in combination with (e.g., as part of) an OpenFlow cache tracking various traffic flows. In this illustration, the cache manager 110 may add the application identifier as a metadata field of the OpenFlow cache, such as when a new entry is added to the OpenFlow cache. Thus, the application identification cache 108 may work in combination with communication networks employing SDN to provide increased efficiency and flexibility in packet routing.

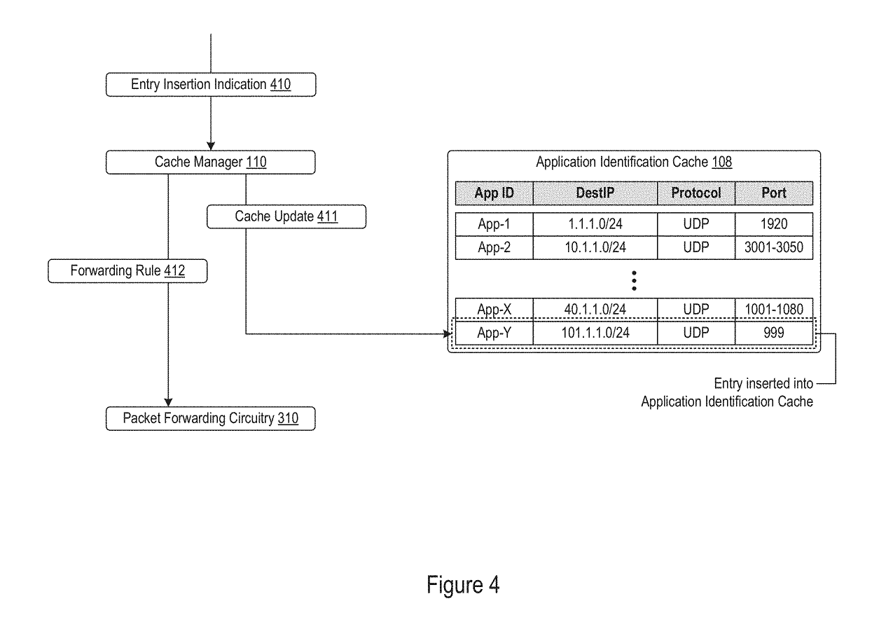

Next, some example techniques through which the cache manager 110 may maintain or update the application identification cache 108 are presented. FIG. 4 shows an example of a cache update by the cache manager 110. In particular, FIG. 4 may illustrate an out-of-band cache update to the application identification cache 108, such as via a control plane of a network managed through SDN techniques.

In FIG. 4, the cache manager 110 receives an entry insertion indication 410. The entry insertion indication 410 may be any communication including entry data for the application identification cache 108. The cache manager 110 may receive the entry insertion indication 410 from an entity external to a network device implementing the application identification cache 108. As examples, the cache manager 110 may receive the entry insertion indication 410 from a network management entity (e.g., SDN controller), an application manager, or an application executing on a client device. A management entity, such as an SDN controller or an application manager, may send the entry insertion indication 410 through an out-of-band data channel or via a network control plane to the cache manager 110, which may cause the cache manager 110 to update its application identification cache 108.

The entry insertion indication 410 may include an application identifier, a corresponding packet characteristic, or both. In response to receiving the entry insertion indication 410, the cache manager 110 may insert an entry into the application identification cache 108, such as through the cache update 411 shown in FIG. 4. The cache update 411 may be a cache insertion instruction (e.g., a memory write), and include an application identifier and corresponding packet characteristic provided in the entry insertion indication 410. In the particular example shown in FIG. 4, the entry insertion indication 410 includes the application identifier “App-Y” and a packet characteristic with destination IP address of “101.1.1.0.124”, protocol used as “UDP”, and destination port of “999”. After insertion through the cache update 411, the application identification cache 108 may include an entry with these values. When a network device subsequently receives network traffic from application “App-Y”, the application identification cache 108 may include this inserted entry for application “App-Y” through which the cache manager 110 may identify application “App-Y” instead of through performing deep packet inspection or other packet recognition processes.

In some examples, the entry insertion indication 410 includes an accompanying forwarding rule for an application identifier. In FIG. 4, the entry insertion indication 410 may include a forwarding rule 412 for the application identifier “App-Y”. Through a received forwarding rule 412, the cache manager 110 may set the forwarding rule 412 for the packet forwarding circuitry 310. In some examples, the forwarding rule 412 is provided separately from the entry insertion indication 410. For instance, an SDN controller may send the forwarding rule 412 via a separate OpenFlow communication different from the entry insertion indication 410.

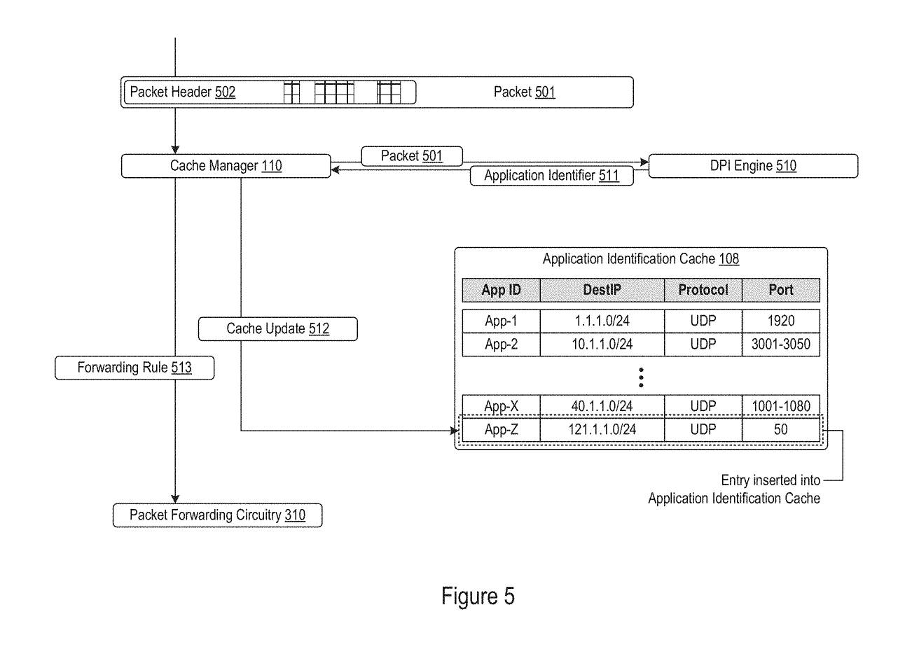

FIG. 5 shows another example of a cache update by the cache manager 110. In the example shown in FIG. 5, the cache manager 110 may perform an in-band cache update, e.g., without receiving an out-of-band instruction or control plane communication.

The cache manager 110 may perform an in-band cache update to the application identification cache 108 in response to a cache miss. To illustrate through FIG. 5, the cache manager 110 may receive the packet 501 which includes the packet header 502. The cache manager 110 may parse the packet 501 (e.g., the packet header 502) to identify a packet characteristic of the packet 501. In FIG. 5, the cache manager 110 determines a packet characteristic with a destination IP address of “121.1.1.0/24”, a protocol used as “UDP”, and a destination port of “50”. Using the determined packet characteristic, the cache manager 110 may perform a lookup into the application identification cache 108, which may result in a cache miss when no entry is stored for this particular packet characteristic.

When the lookup results in a cache miss, the cache manager 110 may identify the corresponding application for the packet 501 in other ways. For instance, the cache manager 110 may send the packet 501 to a deep packet inspection (DPI) engine 510, which may include a processor of the network device. The DPI engine 510 may employ any number of deep packet inspection processes to identify the particular application for which the packet 501 stores application data. The DPI engine 510 may provide the results of the application identification to the cache manager 110, e.g., through an application identifier 511. In FIG. 5, the DPI engine 510 determines the application to which packet 501 belongs as having an application identifier of “App-Z”, which the DPI engine 510 provides to the cache manager 110 as the application identifier 511.

Upon receiving an application identifier 511 or other application identification data from the DPI engine 510, the cache manager 110 may insert an entry into the application identification cache 108. Continuing the example shown in FIG. 5, the cache manager 110 inserts such an entry through the cache update 512, which may include the application identifier 511 as “App-Z” and the packet characteristic extracted from the packet 501. Through the cache update 512, the application identification cache 108 may thus include an inserted entry for “App-Z”, as shown in FIG. 5. For subsequent packets in a traffic flow from the application identified as “App-Z”, the cache manager 110 may recognize the traffic flow as belonging to application “App-Z” through a lookup into the application identification cache 108 instead of through the DPI engine 510.

In some examples, the cache manager 110 configures a forwarding rule for an entry inserted through an in-band cache update. The cache manager 110 may set a forwarding rule 513 for the packet forwarding circuitry 310 before, after, or concurrent to performing an in-band cache update. That is, the cache manager 110 may set the forwarding rule 513 prior to receiving any traffic from a particular application (e.g., as configured through a network management entity) or after receiving a identifying an application flow for a newly recognized application (e.g., in response to the cache miss and DPI application recognition). For a network employing SDN techniques, an SDN controller may send the forwarding rule 513 via an OpenFlow communication, through which a network device (e.g., via the cache manager 110) may configure its packet forwarding circuitry 310.

As described above, the cache manager 110 may maintain and update an application identification cache 108 in various ways. The cache manager 110 may perform a combination in-band and out-of-band cache updates to the application identification cache 108, flexibly allowing for configuration through a network management entity as well as dynamic identification of new application traffic flows received by a network device.

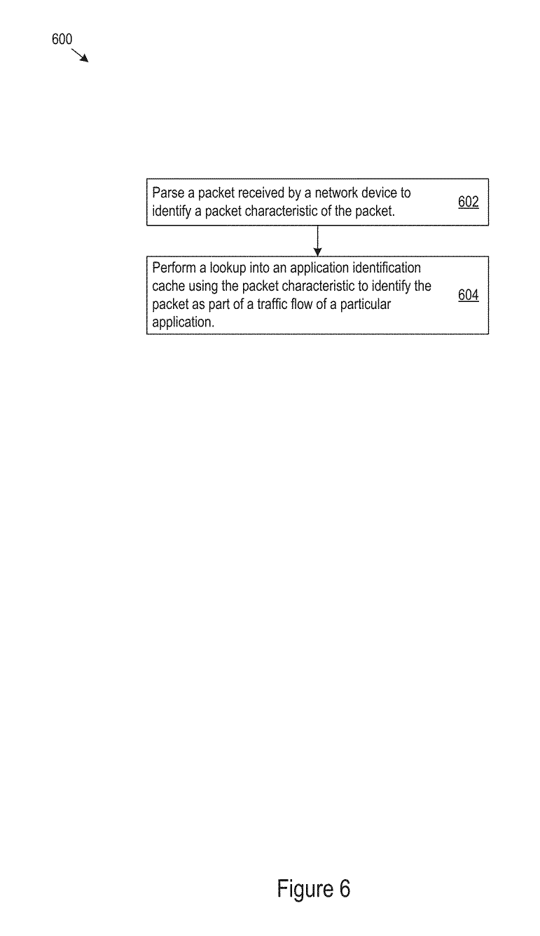

FIG. 6 shows an example of logic 600 that a network device may implement. The network device may implement the logic 600 as hardware, executable instructions stored on a machine-readable medium, or combinations of both. In some examples, the network device implements the logic 600 through the cache manager 110, and the cache manager 110 may perform or execute the logic 600 as a method to support application identification for a traffic flow through an application identification cache 108.

With regards to the logic 600, the network device may parse a packet received by the network device to identify a packet header value of the packet (602). The network device may parse the packet to identify a predetermined set of packet header values. For instance, the network device may parse the packet by identifying, as the packet header value, a destination address, a source address, a transport layer communication protocol used to communicate the packet, a communication port, a metadata value for the packet, or any combination thereof. Then, the network device may perform a lookup into an application identification cache 108 using the packet header value to identify the packet as part of a traffic flow of a particular application (604).

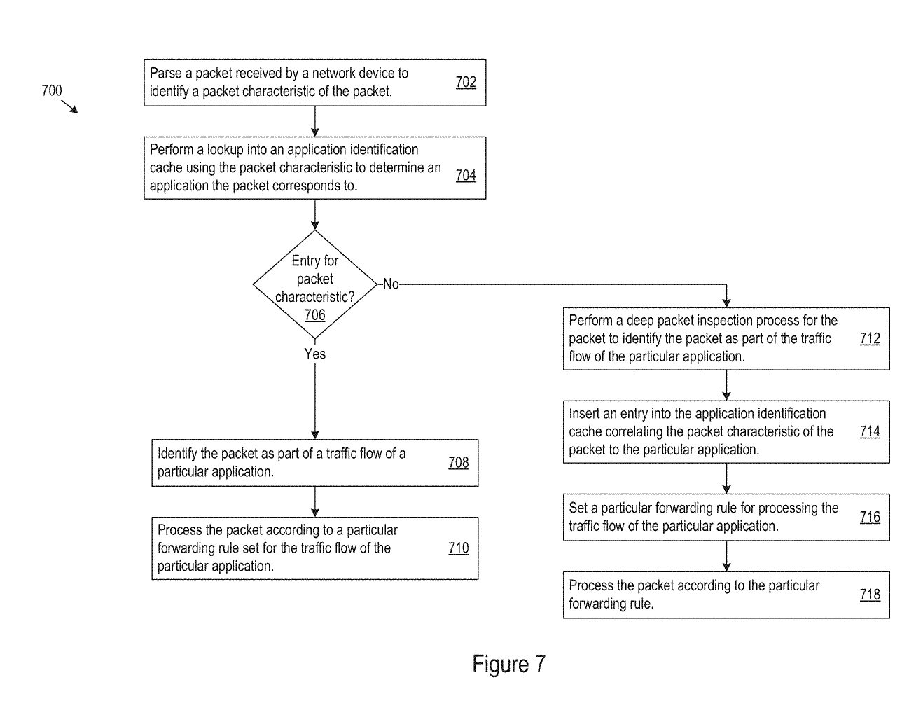

FIG. 7 shows another example of logic 700 that a network device may implement. The network device may implement the logic 700 as hardware, executable instructions stored on a machine-readable medium, or combinations of both. In some examples, the network device implements the logic 700 through combinations of the cache manager 110, packet forwarding circuitry 310, or other routing circuitry or modules. The network device may perform or execute the logic 700 as a method.

The network device may parse a packet received by the network device to identify a packet header value of the packet (702). A packet header value (or set of packet header values) is used as a continuing example of a packet characteristic for the logic 700 of FIG. 7. The network device may perform a lookup into an application identification cache 108 implemented by the network device according to the packet header value to determine an application the packet corresponds to (704). The lookup may return a cache hit or cache miss, depending on whether the application identification cache 108 includes an entry for the packet header value (706).

When the application identification cache 108 includes an entry for the packet header value, the network device may determine the packet as part of a traffic flow of a particular application (708), e.g., the particular application corresponding to an application identifier returned by the application identification cache 108. Thus, the network device may identify the particular application through the application identification cache 108 and without having to perform a deep packet inspection process to identify the corresponding application for the packet. Upon identifying the particular application, the network device may process the packet according to a particular forwarding rule set for the traffic flow of the particular application (710).

When the application identification cache 108 does not include an entry for the packet header value, the network device may identify an application the packet corresponds to in other ways. For example, the network device may perform a deep inspection process for the packet to identify the packet as part of the traffic flow of the particular application (712). Doing so may consume greater resources or time as compared to a lookup into the application identification cache 108. Accordingly, the network device may insert an entry into the application identification cache 108 correlating the packet header value of the packet (or any other packet characteristic) to the particular application (714). The network device may also set a particular forwarding rule for processing the traffic flow of the particular application (716) in response to inserting the entry into the application identification cache 108 and process the packet according to the particular forwarding rule (718).

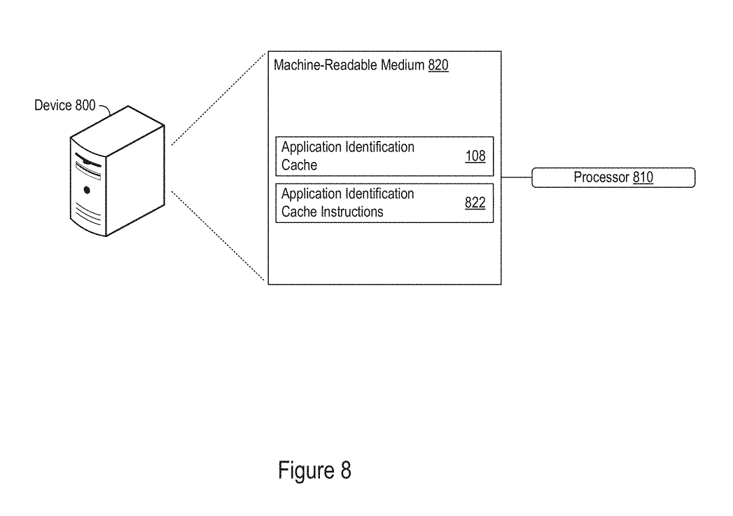

FIG. 8 shows an example of a device 800 that may maintain an application identification cache. The device 800 may be any network device, such as a router, server, switch, gateway, network edge device, and more. The device 800 may include a processor 810. The processor 810 may include a central processing unit (CPU), microprocessor, or any hardware device suitable for executing instructions stored on a machine-readable medium. The device 800 may include a machine-readable medium 820. The machine-readable medium 820 may be any non-transitory electronic, magnetic, optical, or other physical storage device that stores executable instructions, such as the application identification cache instructions 822 shown in FIG. 8. Thus, the machine-readable medium 820 may be, for example, Random Access Memory (RAM), an Electrically-Erasable Programmable Read-Only Memory (EEPROM), a storage drive, an optical disk, and the like. In FIG. 8, the machine-readable medium 820 also stores an application identification cache 108.

The device 800 may execute instructions stored on the machine-readable medium 820 through the processor 810. Executing the instructions may cause the device 800 to perform any combination of the features described herein. For example, executing the application identification cache instructions 822 may cause the device 800 to maintain the application identification cache 108 to store entries pairing application identifiers to packet characteristics of traffic flows. Executing the application identification cache instructions 822 may also cause the device 800 to parse a packet header of a packet to identify a particular packet characteristic of the packet; access the application identification cache 108 according to the particular packet characteristic to determine a particular application identifier for the packet; and process the packet according to a forwarding rule set for a traffic flow of a particular application corresponding to the application identifier.

In some examples, the application identification cache instructions 822 cause the device 800 to maintain the application identification cache 108 by receiving the particular application identifier and particular packet characteristic through a routing control plane (e.g., from a network management entity) and, in response, inserting an entry into the application identification cache 108 correlating the particular application identifier and the particular packet characteristic. As another example, the application identification cache instructions 822 causes the device 800 to maintain the application identification cache 108 by performing a deep packet inspection process for a previously received packet to identify the previously received packet as part of the traffic flow for the particular application, determining the previously received packet includes the particular packet characteristic, and inserting an entry into the application identification cache correlating the particular packet characteristic to the particular application identifier for the particular application.

The methods, devices, circuitry, systems, and logic described above, including the application identification cache 108; cache manager 110; and packet forwarding circuitry 310, may be implemented in many different ways in many different combinations of hardware, logic, circuitry, and executable instructions stored on a machine-readable medium. For example, the cache manager 110 may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above.

The processing capability of the systems, devices, and circuitry described herein, including the cache manager 110 and the packet forwarding circuitry 310, may be distributed among multiple system components, such as among multiple processors and memories, optionally including multiple distributed processing systems. Parameters, databases, and other data structures, such as the application identification cache 108, may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various examples have been described above, many more implementations are possible.

1. A method comprising:
through a network device:
parsing a packet received by the network device to identify a packet header value of the packet; and
performing a lookup into an application identification cache using the packet header value to identify the packet as part of a traffic flow of a particular application.

2. The method of claim 1, wherein parsing the packet comprises identifying, as the packet header value, a destination address, a source address, a transport layer communication protocol used to communicate the packet, a communication port, a metadata value for the packet, or any combination thereof.

3. The method of claim 1, further comprising, when the application identification cache includes an entry for the packet header value:
processing the packet according to a particular forwarding rule set for the traffic flow of the particular application.

4. The method of claim 1, wherein parsing the packet comprises identifying a predetermined set of packet header values of the packet to perform the lookup.

5. The method of claim 1, further comprising inserting an entry into the application identification cache in response to receiving an entry insertion indication through a routing control plane.

6. The method of 1, further comprising, when the application identification cache does not include an entry for the packet header value:
performing a deep packet inspection process for the packet to identify the packet as part of the traffic flow of the particular application; and
inserting an entry into the application identification cache correlating the packet header value of the packet to the particular application.

7. The method of claim 6, further comprising:
setting a particular forwarding rule for processing the traffic flow of the particular application in response to inserting the entry into the application identification cache; and
processing the packet according to the particular forwarding rule.

8. A device comprising:
an application identification cache; and
a cache manager to:
insert an entry into the application identification cache correlating a particular application to a packet characteristic of a traffic flow of the particular application;
parse a packet header of a received packet to identify the packet characteristic; and
access the application identification cache according to the packet characteristic to determine the received packet as part of the traffic flow of the particular application.

9. The device of 8, wherein the packet characteristic comprises a particular destination address, a source address, transport layer communication protocol used to communicate the packet, communication port, packet metadata value, or any combination thereof.

10. The device of claim 8, wherein the cache manager is to insert the entry into the application identification cache in response to receiving an entry insertion indication sent by a network management entity through a routing control plane.

11. The device of claim 8, further comprising packet forwarding circuitry to process the received packet according to a particular forwarding rule set for the traffic flow of the particular application.

12. The device of claim 8, wherein the cache manager is to insert the entry into the application identification cache after:
performing a deep packet inspection process for a previously received packet to identify the particular application; and
determining that the previously received packet includes the packet characteristic.

13. A non-transitory machine-readable medium comprising executable instructions to:
maintain an application identification cache storing entries pairing application identifiers to packet characteristics of traffic flows;
parse a packet header of a packet to identify a particular packet characteristic of the packet;
access the application identification cache according to the particular packet characteristic to determine a particular application identifier for the packet; and
process the packet according to a forwarding rule set for a traffic flow of a particular application corresponding to the application identifier.

14. The non-transitory machine-readable medium of claim 13, wherein the executable instructions are to maintain the application identification cache by:
receiving the particular application identifier and particular packet characteristic through a routing control plane, and
inserting an entry into the application identification cache correlating the particular application identifier and the particular packet characteristic.

15. The non-transitory machine-readable medium of claim 13, wherein the executable instructions are to maintain the application identification cache by:
performing a deep packet inspection process for a previously received packet to identify the previously received packet as part of the traffic flow for the particular application;
determining the previously received packet includes the particular packet characteristic; and
inserting an entry into the application identification cache correlating the particular packet characteristic to the particular application identifier for the particular application.
